(19) United States
(12) Patent Application Publication
(10) Pub. No.: US 2021/0062777 A1
(43) Pub. Date: Mar. 4, 2021

(54) FLUID-DRIVEN APPARATUS FOR PROPULSION AND HYDROPOWER GENERATION

(71) Applicant: Lukas Fazekas, Maple Shade, NJ (US)

(72) Inventor: Lukas Fazekas, Maple Shade, NJ (US)

(21) Appl. No.: 16/560,631

(22) Filed: Sep. 4, 2019

(51) Int. Cl. F03B 9/00; F03B 13/10

(52) U.S. Cl. CPC F03B 9/005; F03B 5/00; F03B 13/10

(57) ABSTRACT

A hydropower generator and a fluid-driven propulsion drive are provided. The hydropower generator includes a frame, a roller attached to the frame, a generator operatively connected to the roller, such that rotation of the roller powers the generator, and an endless belt extending from and operatively engaged with the roller. The endless belt has a proximal end engaged with the roller for rotation thereof, and a plurality of pockets extending from a main surface of the endless belt for receiving a flow of fluid thereby moving the endless belt relative to the frame and driving rotation of the roller, and where each of the plurality of pockets includes an opening facing towards the roller about one of the major sides of the endless belt.

### BACKGROUND OF THE DISCLOSURE

The present disclosure relates generally to a fluid-driven apparatus for propulsion and for hydropower generation. Specifically, the present disclosure relates to a fluid-driven apparatus including an endless belt operatively engaged with one or more rollers and having a plurality of pockets for receiving a flow of fluid that drives the apparatus.

A propeller is a fan-like apparatus configured to convert rotational motion into linear thrust. Conventional fluid-driven propulsion apparatuses such as propellers can be heavyweight, not to mention unsafe due to the spinning blades required of propellers. Further, propellers provide relatively low torque relative to their size and are often formed from metal, which can corrode or oxidize in marine applications such as saltwater. Consequently, such propellers can be inefficient, expensive, and imprecise propulsion apparatuses.

A dam or other hydropower generator is a barrier configured to stop or restrict fluid flow or funnel fluid flow through a smaller cross-sectional area, so as to leverage kinetic energy of the fluid flow to power a generator. Conventional hydropower generators can be large, and do not always interact well with their surrounding environments, such as providing environmentally friendly environments for marine wildlife. Consequently, such conventional hydropower generators can be disruptive to their environments such as having adverse effects on migratory fish populations.

### BRIEF SUMMARY OF THE DISCLOSURE

In a first aspect, the present disclosure provides a hydropower generator that includes a frame, a roller attached to the frame, a generator operatively connected to the roller, such that rotation of the roller powers the generator, and an endless belt extending from and operatively engaged with the roller. The endless belt has a proximal end engaged with the roller for rotation thereof, and a plurality of pockets extending from a main surface of the endless belt for receiving a flow of fluid thereby moving the endless belt relative to the frame and driving rotation of the roller, and where each of the plurality of pockets includes an opening facing towards the roller about one of the major sides of the endless belt.

Further, each of the plurality of pockets include a U-shaped closed end opposite the opening. Each of the plurality of pockets is collapsible. The endless belt is formed from a flexible polymer. The endless belt includes an underside having ridges and the roller includes ridges for engaging the ridges on the endless belt. The hydropower generator further includes a plurality of rollers and a plurality of endless belts respectively mounted to the plurality of rollers. The plurality of rollers are arranged in end to end relation to each other. A bridge may be provided including a pier, and the present hydropower generator is mounted to a bottom portion of the pier.

In a second aspect, the present disclosure provides a fluid-driven propulsion drive that includes a chassis, a drive roller attached to a distal end of the chassis, a driven roller attached to a proximal end of the chassis, a motor operatively connected to the drive roller for driving rotation thereof, and an endless belt extending between the drive roller and driven roller. The endless belt has a plurality of pockets extending from a main surface of the endless belt for capturing fluid therein, and wherein the plurality of pockets having an opening facing proximally towards the proximal end of the chassis.

Further, the motor is attached to the chassis. The fluid-driven propulsion drive further includes a handle. The fluid-driven propulsion drive further includes a plurality of chassis arranged in a tubular fashion. The fluid-driven propulsion drive further includes a handle assembly connected to each of the plurality of chassis. A drone may be provided including the present fluid-driven propulsion drive. A drone may be provided including the present fluid-driven propulsion drive and further including a camera mounted to the chassis. A drone may be provided including the present fluid-driven propulsion drive, and further including a mesh netting for capturing objects therein. A watercraft may be provided including the present fluid-driven propulsion drive. A watercraft may be provided including the present fluid-driven propulsion drive attached to an underside of the watercraft.

### BRIEF DESCRIPTION OF THE SEVERAL VIEWS OF THE DRAWINGS

The foregoing summary, as well as the following detailed description of the exemplary embodiments of the invention, will be better understood when read in conjunction with the appended drawings. For the purpose of illustrating the invention, there are shown in the drawings embodiments, which are presently preferred. It should be understood, however, that the invention is not limited to the precise arrangements and instrumentalities shown.

In the drawings:

FIGS. 1A-1D are various views of a fluid-driven propulsion drive in accordance with an exemplary embodiment of the subject disclosure;

FIG. 1E is an exemplary circuit diagram of the fluid-driven propulsion drive of FIG. 1A;

FIG. 1F is a partial longitudinal view of an exemplary roller of the fluid-driven propulsion drive of FIG. 1A in an unrolled state;

FIG. 1G is a perspective view of exemplary pockets of the fluid-driven propulsion drive of FIG. 1A in a compressed state;

FIGS. 2A-2C are various views of a watercraft including a fluid-driven propulsion drive in accordance with an exemplary embodiment of the subject disclosure;

FIG. 3A is a perspective view of a drone including a fluid-driven propulsion drive in accordance with an exemplary embodiment of the subject disclosure;

FIG. 3B is a perspective view of another drone including a fluid-driven propulsion drive and having a collection member in accordance with an exemplary embodiment of the subject disclosure;

FIG. 4 is a perspective view of a hydropower generator in accordance with an exemplary embodiment of the subject disclosure;

FIG. 5 is a perspective view of a hydropower generator in accordance with an exemplary embodiment of the subject disclosure; and

FIG. 6 is a perspective view of a bridge including the hydropower generator of FIG. 5.

### DETAILED DESCRIPTION

Reference will now be made in detail to the various embodiments of the subject disclosure illustrated in the accompanying drawings. Wherever possible, the same or like reference numbers will be used throughout the drawings to refer to the same or like features. It should be noted that the drawings are in simplified form and are not drawn to precise scale. Certain terminology is used in the following description for convenience only and is not limiting. Directional terms such as top, bottom, left, right, above, below and diagonal, are used with respect to the accompanying drawings.

The term “distal” shall mean away from the center of a body. The term “proximal” shall mean closer towards the center of a body and/or away from the “distal” end. With reference to a hydropower generator, the “proximal end” of the present generator refers to the end of the generator towards the roller(s) and frame, and the “distal end” of the present generator refers to the end of the generator away from the frame and/or away from the “proximal” end. With reference to a fluid-driven propulsion drive, the “distal end” of the present drive refers to the end of the drive towards the motor(s) and the drive roller(s), and the “proximal end” of the present drive refers to the end of the drive towards the (optional) driven roller(s) and/or away from the “distal” end.

The words “inwardly” and “outwardly” refer to directions toward and away from, respectively, the geometric center of the identified element and designated parts thereof. Such directional terms used in conjunction with the following description of the drawings should not be construed to limit the scope of the subject disclosure in any manner not explicitly set forth. Additionally, the term “a,” as used in the specification, means “at least one.” The terminology includes the words above specifically mentioned, derivatives thereof, and words of similar import.

“About” as used herein when referring to a measurable value such as an amount, a temporal duration, and the like, is meant to encompass variations of ±20%, ±10%, ±5%, ±1%, or ±0.1% from the specified value, as such variations are appropriate.

Throughout this disclosure, various aspects of the subject disclosure can be presented in a range format. It should be understood that the description in range format is merely for convenience and brevity and should not be construed as an inflexible limitation on the scope of the subject disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Furthermore, the described features, advantages and characteristics of the exemplary embodiments of the subject disclosure may be combined in any suitable manner in one or more embodiments. One skilled in the relevant art will recognize, in light of the description herein, that the present disclosure can be practiced without one or more of the specific features or advantages of a particular exemplary embodiment. In other instances, additional features and advantages may be recognized in certain embodiments that may not be present in all exemplary embodiments of the subject disclosure.

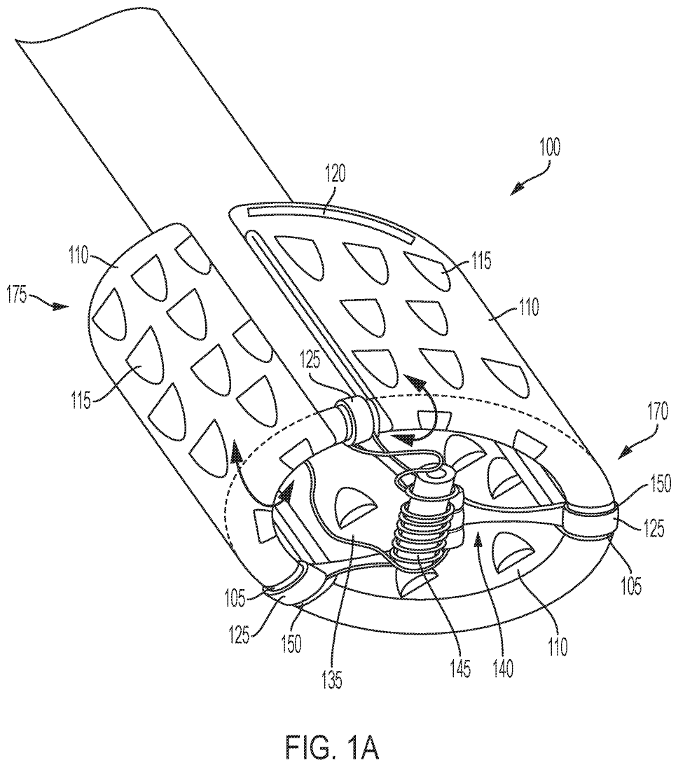

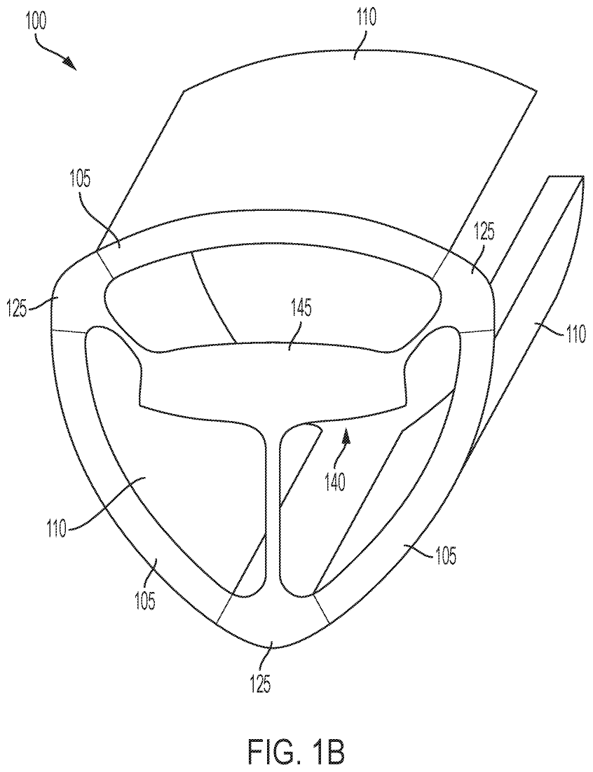

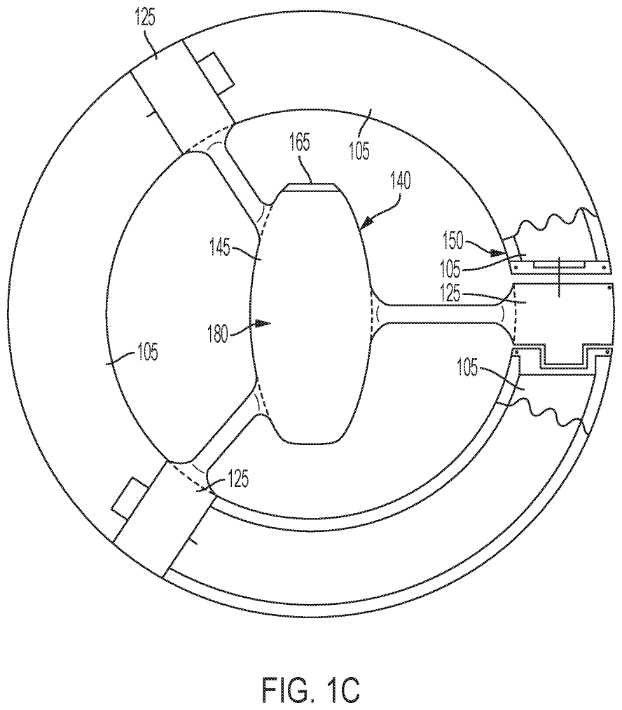

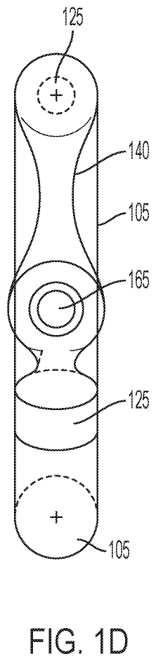

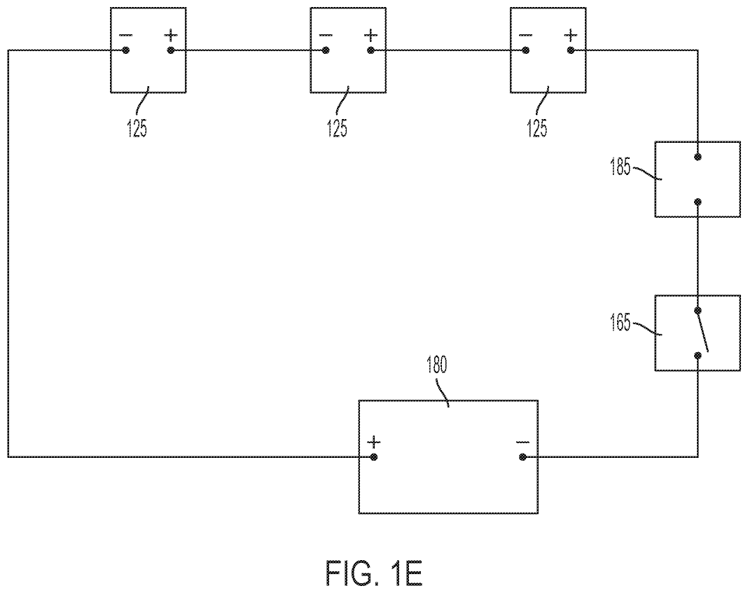

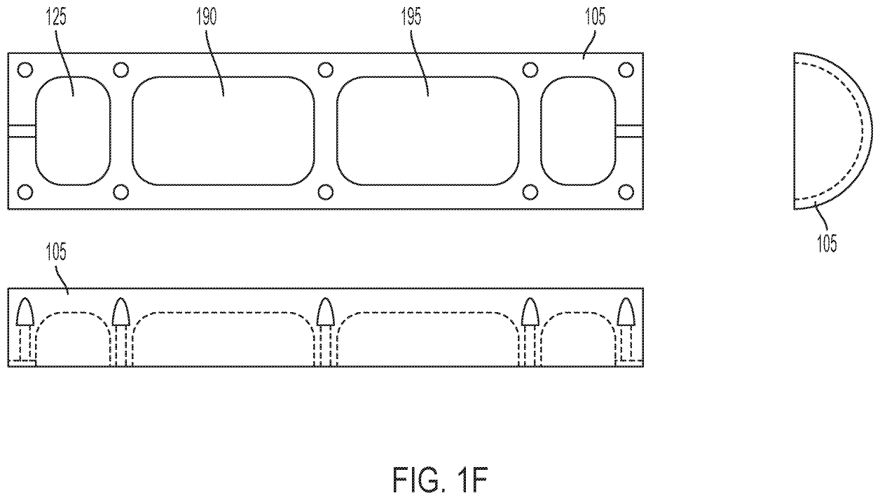

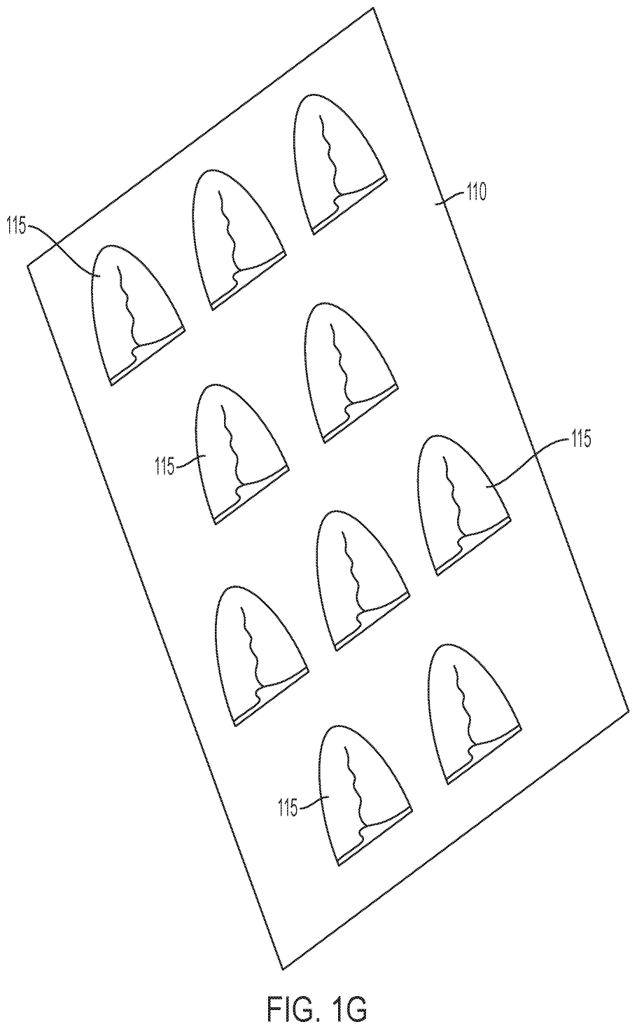

Referring now to the drawings, FIGS. 1A-1D illustrate a fluid-driven propulsion drive 100. The fluid-driven propulsion drive includes a chassis 150, a drive roller 105, a motor 125, and an endless belt 110 having a plurality of pockets 115. In some aspects, the fluid-driven propulsion drive may also include a driven roller 120 and a handle assembly 140.

As seen in FIG. 1A, the chassis 150 includes a distal end 170 and a proximal end 175. The distal end of the chassis is operable to attach a drive roller 105. The proximal end of the chassis is operable to attach an optional driven roller 120. As shown in FIGS. 1A-1D, the chassis may be curved. Referring to FIGS. 1A-1C, the fluid-driven propulsion drive 100 may include a plurality of chassis arranged in a tubular fashion.

The drive roller 105 is attachable to the distal end 170 of the chassis 150. The drive roller is operable to rotate an attached endless belt 110. The drive roller may be curved to match a curve of the chassis 150. In some aspects, the drive roller may include ridges for engaging ridges on an underside of the endless belt 110. As best seen in FIGS. 1A and 1C-1E, in some aspects the drive roller is operable to connect to a drive system including a motor 125. Referring to FIG. 1F, in other aspects the drive roller includes a cavity 190, 195 for storing a battery 180 or ballast. The battery powers the motor to rotate the drive roller. The ballast provides buoyancy to offset the weight of the fluid-driven propulsion drive 100, for example by allowing the drive to float. The fluid-driven propulsion drive 100 may include a plurality of drive rollers, such as three drive rollers. The fluid-driven propulsion drive may also include one, two, four, five, six, seven, eight, nine, ten, or any number of drive rollers suitable for the intended independent control and rotation. As shown in FIGS. 1A-1C, the plurality of drive rollers may be arranged in end to end relation to each other. The plurality of drive rollers provide independent control of the present fluid-driven propulsion drive. Accordingly, the three drive rollers used in the present fluid-driven propulsion drive can provide three-dimensional control of the present fluid-driven propulsion drive.

The driven roller 120 is attachable to the proximal end 175 of the chassis 150. The driven roller provides optional structure to the endless belt and the proximal end of the chassis. The driven roller is rotatable when the motor 125 rotates the drive roller 105, thereby rotating the endless belt 110 that is attached to the drive roller and the driven roller. In some aspects, the driven roller may include ridges for engaging ridges on an underside of the endless belt 110 to facilitate rotation and control of the endless belt. The fluid-driven propulsion drive 100 may include a plurality of driven rollers that corresponds to the number of drive rollers 105, such as three driven rollers. The fluid-driven propulsion drive may also include one, two, four, five, six, seven, eight, nine, ten, or any number of driven rollers suitable for facilitating the intended independent control and rotation. As shown in FIG. 1A, the plurality of driven rollers may be arranged in end to end relation to each other.

The motor 125 is attachable to the chassis 150 and operatively connected to the drive roller 105. The motor drives rotation of the drive roller, thereby rotating the endless belt. The fluid-driven propulsion drive 100 may include a plurality of motors, one for each drive roller. By way of non-limiting example, FIGS. 1A and 1C-1E illustrate the present fluid-driven propulsion drive including three motors operatively connected to three drive rollers, although the fluid-driven propulsion drive may include any number of suitable drive rollers and motors, such as one, two, four, five, six, seven, eight, nine, ten, or more drive rollers and motors. The motors provide independent control to steer or remotely control the present fluid-driven propulsion drive. Accordingly, three motors operatively connected to three drive rollers can provide independent three-dimensional control of the present fluid-driven propulsion drive.

The endless belt 110 extends from and is operatively engaged with the drive roller 105. The endless belt extends between the drive roller 105 and the driven roller 120. The endless belt may be formed from a flexible polymer. The flexible polymer may be chosen having a pre-determined thickness. The flexible polymer may be chosen to allow graphics to be applied to the endless belt and thereby provide ornamental effects such as decoration. In some aspects, the endless belt may include ridges along an underside for engaging with mating ridges on the drive roller 105 or the driven roller 120. As best seen in FIG. 1A, in some aspects the sides of the endless belt may be connected lengthwise to form a closed system such as a tube. The tube may be filled with fluid to aid with propulsion. If the endless belt is formed as a tube, then the driven roller 120 may be optional. The endless belt has a main surface and a plurality of pockets 115.

The plurality of pockets 115 extend from the main surface of the endless belt 110. The pockets capture fluid in the pocket, as described in further detail below. The pockets have an opening facing proximally towards the proximal end 175 of the chassis 150. The pockets may include a U-shaped closed end opposite the opening. As with the endless belt, the pockets may be formed from a flexible polymer. For example, the pockets may be formed from the same polymer used to form the endless belt. When the motor 125 rotates the drive roller 105, the endless belt rotates around the drive roller. The drive roller thereby moves the endless belt to move the pockets proximally. The openings of the pockets are operable to allow the pockets to fill with fluid to provide a distally-directed propulsion force due to the fluid pushing against the U-shaped closed end of the pocket, thereby propelling the present fluid-driven propulsion drive 100. Referring to FIG. 1G, the pockets may also be collapsible. When the pockets rotate around the driven roller 120 due to rotation of the drive roller 105 and endless belt 110, the collapsible pockets are configured to collapse so as to reduce drag forces that might otherwise slow the distally-directed propulsion force.

The handle assembly 140 includes a handle 145 and a plurality of arms extending from the handle. The handle may be sized and contoured to facilitate gripping by a hand 135 of a user, as described in further detail below. The plurality of arms extend radially from the handle to each of the plurality of chassis 150. For example, the arms may be attachable to a space between each drive roller 105 at each of the plurality of chassis. As best seen in FIG. 1C, the arms may attach to the motor 125. The handle assembly may also include a cavity. The cavity may be sized to store a portable component such as a battery or a camera. The battery can power each motor 125 and/or provide a boost to increase available power to each motor.

A switch 165 may be operatively connected to the handle assembly 140, as shown in FIGS. 1C-1E. The switch is operable to activate or deactivate the fluid-driven propulsion drive 100. Referring to FIG. 1E, an exemplary circuit diagram is shown including the switch 165 which, when activated, completes a circuit between the battery 180 and the motor 125 to power the motors 125 and operate the present fluid-driven propulsion drive. For example, in some aspects the switch 165 may be activated when the hand 135 depresses an actuator. In other aspects, the switch may be a pressure cut-off switch such as the pressure cut-off switch 185 shown in FIG. 1E. For example, the pressure cut-off switch may be configured to depress the actuator or otherwise activate the cut-off switch when the present fluid-driven propulsion drive 100 reaches a depth of a pre-determined water pressure. Such a cut-off switch can deactivate the motors 125 and allow any ballast stored in the rollers 105, 120 to take over, thereby providing an additional safety measure if the present fluid-driven propulsion drive is used, for example, as a personal propulsion device.

In operation, the fluid-driven propulsion drive 100 may be configured as a handheld apparatus. The user grasps the fluid-driven propulsion drive 100 at the handle assembly 140 with the fingers of the hand 135 around the handle 145 and the thumb of the hand 135 near an actuator of the switch 165. The switch 165 is operable to activate or deactivate propulsion of the fluid-driven propulsion drive, as described above. Upon activation, the motors 125 rotate the drive roller 105 thereby rotating the endless belt 110 and moving the endless belt 110 proximally toward the proximal end 175 of the chassis 150. When the main surface of the endless belt 110 moves proximally, each opening of each pocket 115 fills with fluid thereby creating a distally-directed propulsion force. When the pockets 115 rotate around the driven roller 120 due to rotation of the drive roller 105 and movement of the endless belt 110, the collapsible pockets collapse so as to reduce drag forces that might otherwise slow the distally-directed propulsion force.

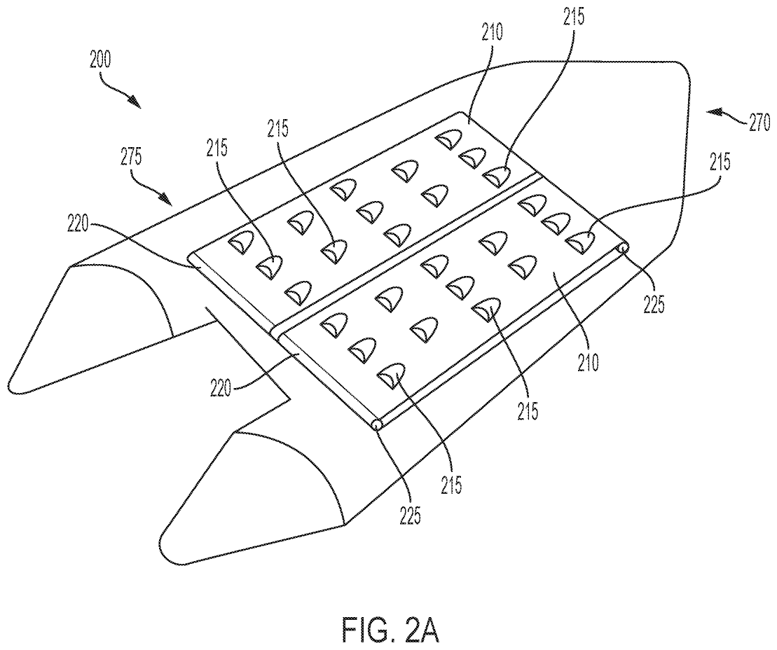

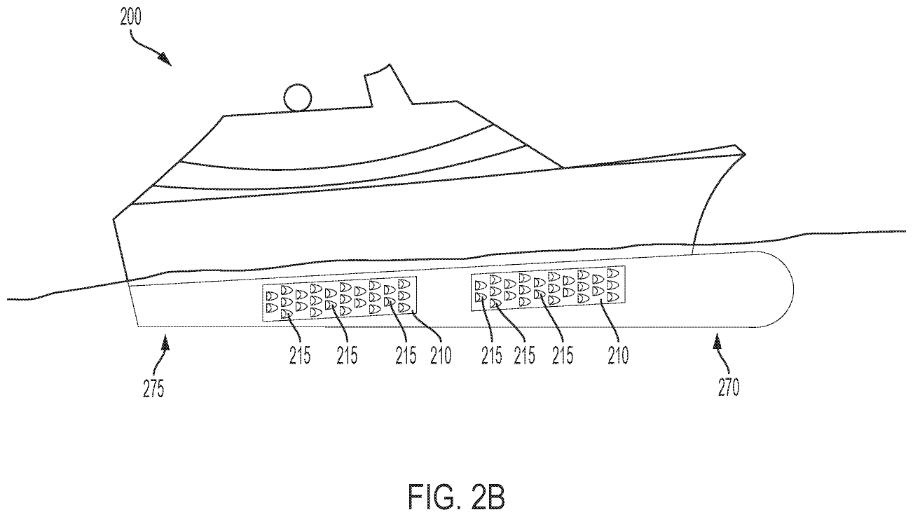

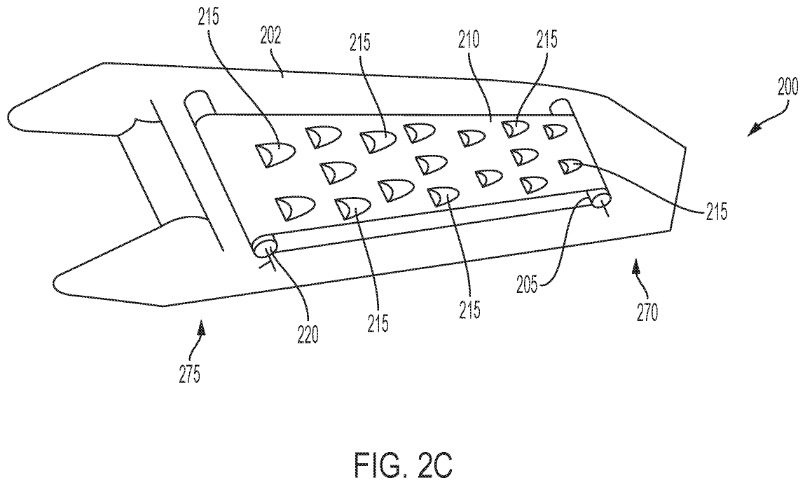

Referring to FIGS. 2A-2C, an exemplary watercraft 200 is configured as shown having a fluid-driven propulsion drive. As best seen in FIGS. 2A and 2C, the fluid-driven propulsion drive of the watercraft 200 includes a chassis, a drive roller 205, a driven roller 220, a motor 225, and an endless belt 210 having a plurality of pockets 215. The chassis is configured and operable similar to the chassis 150. The drive roller 205 and driven roller 220 are configured and operable similar to the drive roller 105 and driven roller 120, respectively. The motor 225 is configured and operable similar to the motor 125. The endless belt 210 and the plurality of pockets 215 are configured and operable similar to the endless belt 110 and the plurality of pockets 115, respectively.

In operation, the watercraft 200 activates the motor 225 at the distal end 270 of the chassis. The motor 225 rotates the drive roller 205 thereby moving the endless belt 210 proximally towards the proximal end 275 of the chassis. As the main surface of the endless belt 210 moves proximally, each opening of each pocket 215 fills with fluid thereby creating a distally-directed propulsion force to propel the watercraft 200. When the pockets 215 rotate around the driven roller 220 due to rotation of the drive roller 205 and movement of the endless belt 210, the collapsible pockets collapse so as to reduce drag forces that might otherwise slow the distally-directed propulsion force.

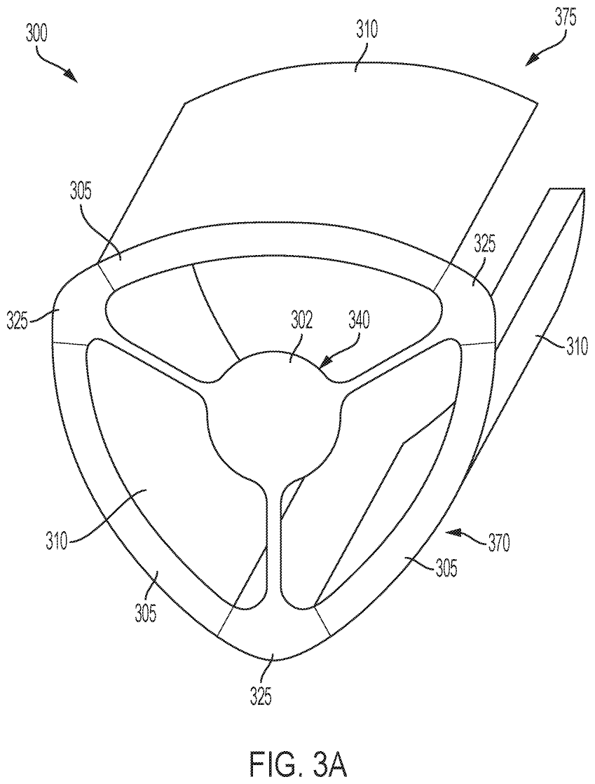

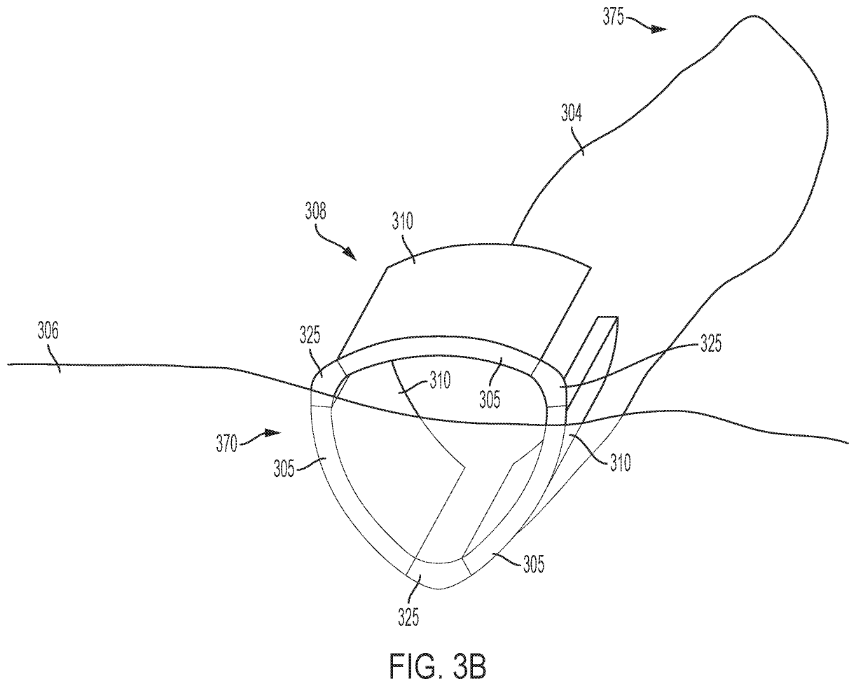

Referring to FIG. 3A, an exemplary drone 300 is configured as shown having a fluid-driven propulsion drive. The drone 300 may be an underwater drone, for example for tagging roving sharks or whales. The fluid-driven propulsion drive of the drone 300 includes a chassis, a drive roller 305, a motor 325, a handle assembly 340, and an endless belt 310 having a plurality of pockets (not shown). The chassis is configured and operable similar to the chassis 150. The drive roller 305 is configured and operable similar to the drive roller 105. The motor 325 is configured and operable similar to the motor 125. The endless belt 310 and the plurality of pockets are configured and operable similar to the endless belt 110 and the plurality of pockets 115, respectively.

The handle assembly 340 is configured and operable similar to the handle assembly 140. The handle assembly 340 includes a central camera 302. The central camera has utility for marine exploration, for example for capturing photographs or video of aquatic wildlife, such as roving sharks or whales. A plurality of arms extend radially from the camera to each of the plurality of the chassis. For example, the arms may be attachable to a space between each drive roller 305 at each of the plurality of chassis. As best seen in FIG. 3A, the arms may attach to the motor 325.

In operation, the drone 300 activates the motor 325 at the distal end 370 of the chassis. The motors 325 may be operated by remote control and steered independently to facilitate three-dimensional mobility and control, as described in further detail above. The motor 325 rotates the drive roller 205 thereby moving the endless belt 310 proximally towards the proximal end 375 of the chassis. As the main surface of the endless belt 310 moves proximally, each opening of each pocket fills with fluid thereby creating a distally-directed propulsion force to propel the drone 300. When the pockets rotate around due to rotation of the drive roller 305 and movement of the endless belt 310, the collapsible pockets collapse so as to reduce drag forces that might otherwise slow the distally-directed propulsion force.

Referring to FIG. 3B, an exemplary drone 308 is configured as shown having a fluid-driven propulsion drive. The drone 308 is configured and operable similar to the drone 300. However, the drone 308 includes a handle assembly having a collection member 304 instead of or in addition to the camera 302.

The collection member 304 may include a net. The net may be formed from a mesh netting. For example, the netting may be formed with a cross-hatched mesh for added durability. In operation, when the drone 308 is inserted below sea level 306 and propelled distally by the motor 325, drive roller 305, and endless belt 310, the collection member is configured to trail towards the proximal end 375 of the drone 308 to help clean undesired debris or trash that would otherwise clutter bodies of water. As described in further detail above, the plurality of motors 325 and drive rollers 305 may be remote controlled and steered independently to provide precise three-dimensional mobility and control.

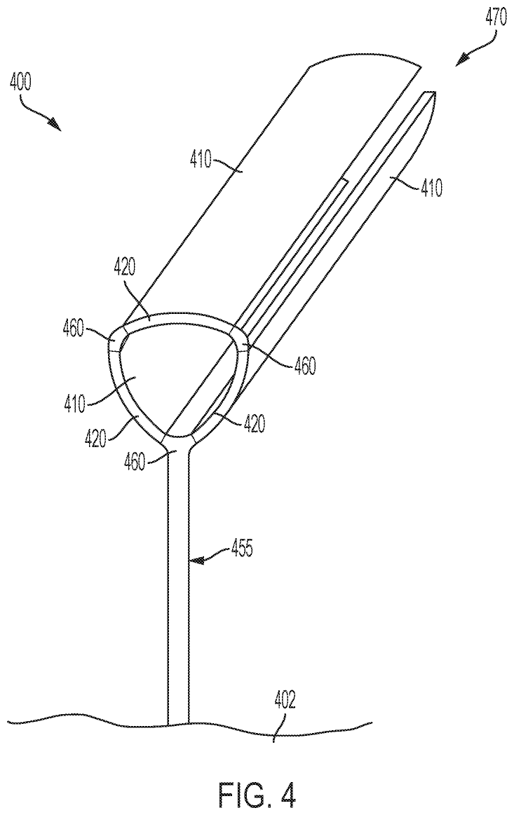

Referring now to FIG. 4, the hydropower generator 400 includes a frame 455, a roller 420 attached to the frame, a generator 460 operatively connected to the roller, and an endless belt 410 extending from and operatively engaged with the roller.

The frame 455 is operable to attach a roller 420. As shown in FIG. 4, a portion of the frame may be curved to arrange a plurality of rollers 420 end to end. Accordingly, the hydropower generator 400 may include a plurality of frames arranged in a tubular fashion.

The roller 420 is attached to the frame 455. The roller 420 is similar to the driven roller 120, as described in detail above. The roller is rotatable upon movement of the endless belt 410 that is attached to the roller. Rotation of the roller is operable to power the generator 460. In some aspects, the roller may include ridges for engaging ridges on an underside of the endless belt 410 to facilitate rotation of the roller upon movement of the endless belt. The hydropower generator 400 may include a plurality of rollers, such as three rollers. The hydropower generator may also include one, two, four, five, six, seven, eight, nine, ten, or any number of rollers suitable for facilitating the intended hydropower generation. As shown in FIG. 4, the plurality of rollers may be arranged in end to end relation to each other.

The generator 460 is operatively connected to the roller 420, such that rotation of the roller powers the generator. Specifically, fluid-driven movement of the endless belt 410 rotates the roller 420 to power the generator 460. The hydropower generator 400 may include a plurality of generators, one for each roller. By way of non-limiting example, FIG. 4 illustrates the present hydropower generator including three generators operatively connected to three rollers, although the hydropower generator may include any number of rollers and generators suitable for hydropower generation, such as one, two, four, five, six, seven, eight, nine, ten, or more rollers and generators.

The endless belt 410 includes a proximal end 475 and a distal end 470. The proximal end of the endless belt is engaged with the roller 420 for rotation of the roller, as described in further detail below. The distal end of the endless belt is opposite the proximal end and distal to the frame 455. The endless belt may be formed from a flexible polymer. The flexible polymer may be chosen having a pre-determined thickness. The flexible polymer may be chosen to allow graphics to be applied to the endless belt and thereby provide ornamental effects such as decoration. In some aspects, the endless belt may include ridges along an underside for engaging with mating ridges on the roller 420. The endless belt has a main surface and a plurality of pockets (not shown).

The plurality of pockets are configured and operable similar to the plurality of pockets 115. The pockets extend from the main surface of the endless belt 410. The pockets capture fluid in the pocket, as described in further detail below. The pockets have an opening facing towards the roller 420 about one of the major sides of the endless belt, e.g., an opening facing proximally towards the proximal end 475 of the endless belt. The pockets may include a U-shaped closed end opposite the opening, e.g., a closed end facing distally towards the distal end 470 of the endless belt. As with the endless belt, the pockets may be formed from a flexible polymer. For example, the pockets may be formed from the same polymer used to form the endless belt. The openings of the pockets are operable to allow the pockets to fill with fluid to provide a distally-directed biasing force due to the fluid entering the opening of the pocket and then pushing against the U-shaped closed end of the pocket. Such biasing force is operable to bias and move the endless belt relative to the frame 455 and thereby drive rotation of the roller 420. When the fluid-filled pockets move the endless belt relative to the frame and drive rotation of the roller 420, the roller thereby powers the generator 460 so as to generate hydropower energy. The pockets may also be collapsible, as described above with regard to the pockets 115. When the pockets rotate around the roller 420 due to fluid-driven movement of the pockets and endless belt 410, the collapsible pockets are configured to collapse so as to reduce drag forces that might otherwise slow the proximally-directed biasing force.

In operation, the hydropower generator 400 uses fluid flow to power the generator 460. The frame 455 may be inserted and anchored into a seabed 402. The plurality of pockets extending from the main surface of the endless belt 410 capture fluid in the pockets, thereby creating a distally-directed biasing force to move the pockets and endless belt 410 distally and rotate the rotors 420 accordingly. Rotation of the rotors 420 powers the corresponding generators 460. Further, when the pockets rotate around the roller 420 due to motion of the pockets and endless belt 410, the collapsible pockets collapse so as to reduce drag forces that might otherwise slow the distally-directed biasing force.

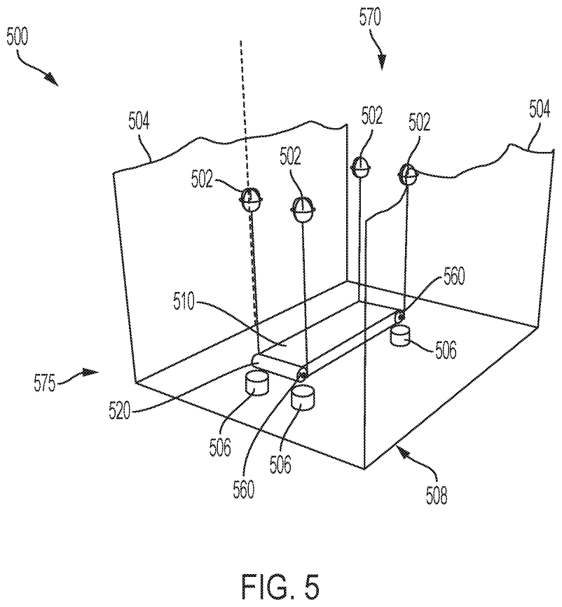

Referring to FIG. 5, the hydropower generator 500 includes a frame, a roller 520 attached to the frame, a generator 560 operatively connected to the roller, and an endless belt 510 extending from and operatively engaged with the roller. The frame is configured and operable similar to the frame 455. The roller 520 is configured and operable similar to the roller 420. The generator 560 is configured and operable similar to the generator 460. The endless belt 510 is configured and operable similar to the endless belt 410. In some aspects, the hydropower generator also includes one or more buoys 502 attached to the roller 520 or to the frame, and one or more pylons 506 attached to the roller 520 or the frame. The buoys 502 are operable to facilitate future location and identification of the hydropower generator 500 after it has been placed along the riverbed 508. The pylons 506 are configured to stabilize the hydropower generator 500 after it has been placed along the riverbed 508.

In operation, the hydropower generator 500 uses fluid flow to power the generator 560. The hydropower generator 500 may be inserted into the water 504. The plurality of pockets extending from the main surface of the endless belt 510 capture fluid in the pockets, thereby creating a distally-directed biasing force to move the pockets and endless belt 510 distally (e.g., toward the distal end 570 of the endless belt 510 and away from the proximal end 575 of the endless belt 510) and rotate the rotors 520 accordingly. Rotation of the rotors 520 powers the corresponding generators 560. Further, when the pockets rotate around the roller 520 due to motion of the pockets and endless belt 510, the collapsible pockets collapse so as to reduce drag forces that might otherwise slow the distally-directed biasing force.

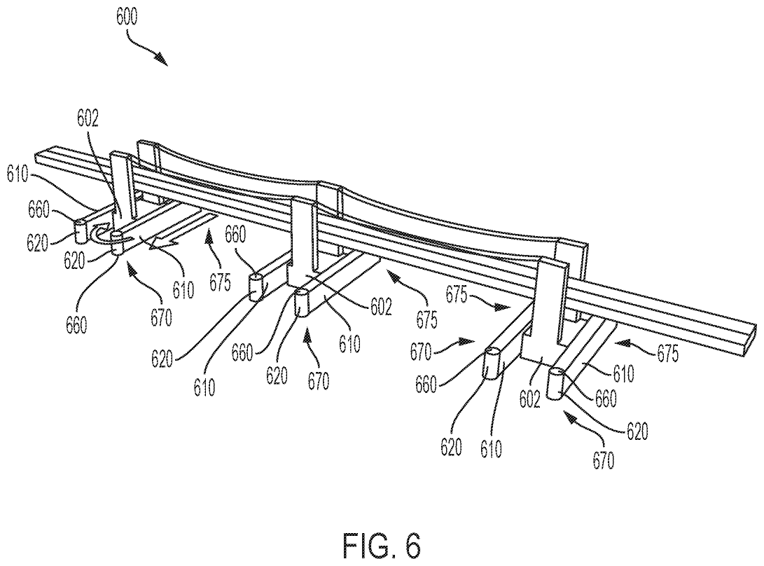

Referring to FIG. 6, an exemplary bridge 600 is configured as shown having a pier 602 and a hydropower generator mounted to a bottom portion of the pier 602. The hydropower generator includes a frame, a roller 620 attached to the frame, a generator 660 operatively connected to the roller, and an endless belt 610 extending from and operatively engaged with the roller. The frame is configured and operable similar to the frame 455. The roller 620 is configured and operable similar to the roller 420. The generator 660 is configured and operable similar to the generator 460. The endless belt 610 is configured and operable similar to the endless belt 410.

In operation, the hydropower generator 600 uses fluid flow to power the generator 660. The plurality of pockets extending from the main surface of the endless belt 610 capture fluid in the pockets, thereby creating a distally-directed biasing force to move the pockets and endless belt 610 distally (e.g., toward the distal end 670 of the endless belt 610 and away from the proximal end 675 of the endless belt 610) and rotate the rotors 620 accordingly. Rotation of the rotors 620 powers the corresponding generators 660. Further, when the pockets rotate around the roller 620 due to motion of the pockets and endless belt 610, the collapsible pockets collapse so as to reduce drag forces that might otherwise slow the distally-directed biasing force.

The exemplary embodiments of the fluid-driven propulsion drive discussed herein provide numerous advantages over conventional fluid-driven propulsion. For example, the fluid-driven propulsion drive 100 is substantially lighterweight compared to a conventional propeller which can generally be formed from metal. In contrast, the endless belt 110 and the plurality of pockets 115 can be formed from a flexible polymer that is selected to be lightweight and durable. The materials selected for the endless belt 110 can exhibit improved longevity and durability due to antimicrobial additives or use of a mesh material. Further, the fluid-driven propulsion drive 100 can be adapted for watercraft propulsion, such as the watercraft 200, or used for facilitating ocean clean up or exploration. Additionally, the fluid-driven propulsion drive 100 can be retrofit into existing fleets, either supplementing or replacing conventional propellers. The three-dimensional arrangement of the rollers 105, 120, motors 125, and the endless belts 110 provide improved maneuverability and control, and greater linear thrust compared to conventional propellers. The arrangement of the rollers 105, 120, motors 125, and the endless belts 110 are also safer for use than conventional propellers with spinning blades that can result in undesired accidents. Further, the use of an electric-powered battery 180 lowers environmental consequences.

Likewise, the exemplary embodiments of the hydropower generator discussed herein provide numerous advantages over conventional hydropower generators. For example, the hydropowered generator 400 is substantially lighterweight compared to a conventional dam which can generally be formed from concrete and requires significant impacts to land use and the natural environment. In contrast, hydropowered generator 400 can be manufactured as small or as large as needed, and as such exhibits fewer environmental impacts, such as far less disruption to migratory fish populations.

It will be appreciated by those skilled in the art that changes could be made to the various aspects described above without departing from the broad inventive concept thereof. It is to be understood, therefore, that the subject application is not limited to the particular aspects disclosed, but it is intended to cover modifications within the spirit and scope of the subject application as defined by the appended claims.

I claim:

1. A hydropower generator comprising:
a frame;
a roller attached to the frame;
a generator operatively connected to the roller, such that rotation of the roller powers the generator; and
an endless belt extending from and operatively engaged with the roller, the endless belt having:
a proximal end engaged with the roller for rotation thereof,
a distal end opposite the proximal end and distal to the frame, and
a plurality of pockets extending from a main surface of the endless belt for receiving a flow of fluid thereby moving the endless belt relative to the frame and driving rotation of the roller, and wherein each of the plurality of pockets includes an opening facing towards the roller about one of the major sides of the endless belt.

2. The hydropower generator of claim 1, wherein each of the plurality of pockets include a U-shaped closed end opposite the opening.

3. The hydropower generator of claim 1, wherein each of the plurality of pockets is collapsible.

4. The hydropower generator of claim 1, wherein the endless belt is formed from a flexible polymer.

5. The hydropower generator of claim 1, wherein the endless belt includes an underside having ridges and the roller includes ridges for engaging the ridges on the endless belt.

6. The hydropower generator of claim 1, further comprising a plurality of rollers and a plurality of endless belts respectively mounted to the plurality of rollers.

7. The hydropower generator of claim 6, wherein the plurality of rollers are arranged in end to end relation to each other.

8. A bridge comprising:
a pier; and
the hydropower generator of claim 1 mounted to a bottom portion of the pier.

9. A fluid-driven propulsion drive comprising:
a chassis;
a drive roller attached to a distal end of the chassis;
a driven roller attached to a proximal end of the chassis;
a motor operatively connected to the drive roller for driving rotation thereof;
an endless belt extending between the drive roller and driven roller, the endless belt having:
a plurality of pockets extending from a main surface of the endless belt for capturing fluid therein, and wherein the plurality of pockets having an opening facing proximally towards the proximal end of the chassis.

10. The fluid-driven propulsion drive of claim 9, wherein the motor is attached to the chassis.

11. The fluid-driven propulsion drive of claim 9, further comprising a handle.

12. The fluid-driven propulsion drive of claim 9, further comprising a plurality of chassis arranged in a tubular fashion.

13. The fluid-driven propulsion drive of claim 12, further comprising a handle assembly connected to each of the plurality of chassis.

14. A drone comprising the fluid-driven propulsion drive of claim 9.

15. A drone comprising the fluid-driven propulsion drive of claim 9, further comprising a camera mounted to the chassis.

16. A drone comprising the fluid-driven propulsion drive of claim 9, further comprising a mesh netting for capturing objects therein.

17. A watercraft comprising the fluid-driven propulsion drive of claim 9.

18. A watercraft comprising the fluid-driven propulsion drive of claim 9 attached to an underside of the watercraft.
